(19) United States
(12) Patent Application Publication
(10) Pub. No.: US 2022/0171054 A1
(43) Pub. Date: Jun. 2, 2022

(54) ON-VEHICLE OBJECT DETECTION SYSTEM

(71) Applicant: Mitsubishi Electric Corporation, Tokyo (JP)

(72) Inventor: Naoyuki TSUSHIMA, Tokyo (JP)

(73) Assignee: Mitsubishi Electric Corporation, Tokyo (JP)

(21) Appl. No.: 17/599,870

(22) PCT Filed: May 14, 2019
(86) PCT No.: PCT/JP2019/019036

§ 371 Date: Sep. 29, 2021

(51) Int. Cl. G01S 13/931; G01S 7/40

(52) U.S. Cl. CPC G01S 13/931; G01S 7/40

(57) ABSTRACT

A plurality of target reflection levels detected by a plurality of object detection apparatuses mounted to a vehicle are received, and a difference between target reflection levels of two or more targets detected as the same target or the same type of target is calculated. When this difference exceeds a range of values determined in advance, a control apparatus determines that any of the plurality of object detection apparatuses has an abnormality. Accordingly, occurrence of an abnormality in the object detection apparatus can be determined less erroneously than before, without causing statistical processing to be complicated.

### TECHNICAL FIELD

The present disclosure relates to an on-vehicle object detection system.

### BACKGROUND ART

To date, as an example of an on-vehicle radar apparatus that detects decrease in detection performance due to an attached substance such as mud or snow, and that determines an abnormality in a radar apparatus, a radar apparatus described in Patent Document below is known. That is, a transmission wave is transmitted to a plurality of targets, reflected waves from the targets are received by reception means, the number of reception signals in which the signal level of the reception signal regarding the reflection intensity received is in a range of failure level values is counted, and a failure state is determined on the basis of the count value.

### CITATION LIST

### Patent Document

Patent Document 1: Japanese patent No. 3488610

### SUMMARY OF THE INVENTION

### Problems to be Solved by the Invention

However, the reflection intensity of a target is different depending on the type of the target. For example, reflection from a rear portion of a bed of a truck is strong, and reflection from a rear portion of a small automobile is weak. In addition, the reflection intensity also changes depending on the distance between a target and a radar apparatus. For example, when the distance from a target to a radar apparatus is long, the reflection intensity that is observed is also weak.

Such a difference in the reflection intensity may cause an erroneous determination that there is an abnormality even when no abnormality has occurred. In contrast, when a threshold for determining an abnormality is set to be high in order to prevent erroneous abnormality determination, there is a risk that it is not determined that there is an abnormality even when an abnormality has occurred. This results in a traveling scene where an abnormality in a radar apparatus cannot be accurately determined as an abnormality. In addition, statistical processing such as counting the number of times of exceeding a threshold requires a certain time period before determination of an abnormality is made. This poses a problem that an abnormality cannot be found early, for example.

The present disclosure has been made in order to solve the above-described problem. An object of the present disclosure is to provide an on-vehicle object detection system that can determine, less erroneously than before, occurrence of an abnormality in an object detection apparatus such as a radar apparatus, without causing statistical processing to be complicated.

### Solution to the Problems

An on-vehicle object detection system according to the present disclosure includes:

a plurality of object detection apparatuses mounted to a vehicle;

a target reflection level reception unit for receiving a plurality of target reflection levels detected by the plurality of object detection apparatuses; and

an object detection apparatus abnormality determination unit for calculating a difference between target reflection levels of two or more targets detected as a same target or a same type of target, and for determining, when the difference exceeds a range of values determined in advance, that any of the plurality of object detection apparatuses has an abnormality.

### Effect of the Invention

According to the on-vehicle object detection system of the present disclosure, target reflection levels are compared between a plurality of object detection apparatuses. Therefore, even when the targets are positioned at various distances and the reflection levels vary in accordance therewith, the presence or absence of an abnormality can be determined.

### BRIEF DESCRIPTION OF THE DRAWINGS

FIG. 1 is a schematic configuration diagram of an on-vehicle object detection system of embodiment 1.

FIG. 2 is a block configuration diagram of a control apparatus of embodiment 1.

FIG. 3 is a diagram describing basic operation of the on-vehicle object detection system of embodiment 1.

FIG. 4 is a flowchart describing basic operation of the on-vehicle object detection system of embodiment 1.

FIG. 5 is diagram showing an abnormality determination result regarding two radar apparatuses.

FIG. 6 is another diagram showing an abnormality determination result regarding two radar apparatuses.

FIG. 7 is a diagram showing an abnormality determination result regarding three radar apparatuses.

FIG. 8 is a flowchart describing additional operation of the on-vehicle object detection system of embodiment 1.

FIG. 9 is a flowchart describing another additional operation of the on-vehicle object detection system of embodiment 1.

FIG. 10 is a diagram describing basic operation of the on-vehicle object detection system of embodiment 2.

FIG. 11 is a flowchart describing basic operation of the on-vehicle object detection system of embodiment 2.

FIG. 12 is a diagram describing basic operation of the on-vehicle object detection system of embodiment 3.

FIG. 13 is a flowchart describing basic operation of the on-vehicle object detection system of embodiment 3.

FIG. 14 is a diagram describing basic operation of the on-vehicle object detection system of embodiment 4.

FIG. 15 is a flowchart describing basic operation of the on-vehicle object detection system of embodiment 4.

FIG. 16 is a diagram describing basic operation of the on-vehicle object detection system of embodiment 5.

FIG. 17 is a flowchart describing basic operation of the on-vehicle object detection system of embodiment 5.

FIG. 18 is a block configuration diagram of the control apparatus of embodiment 5.

### DESCRIPTION OF EMBODIMENTS

Hereinafter, a preferred embodiment of an on-vehicle object detection system according to the present disclosure will be described with reference to the drawings. The same parts and corresponding parts are denoted by the same reference characters, and detailed description thereof is omitted. Also, in embodiments after this embodiment, description of parts denoted by the same reference characters is omitted.

### Embodiment 1

### [Basic Configuration and Basic Operation]

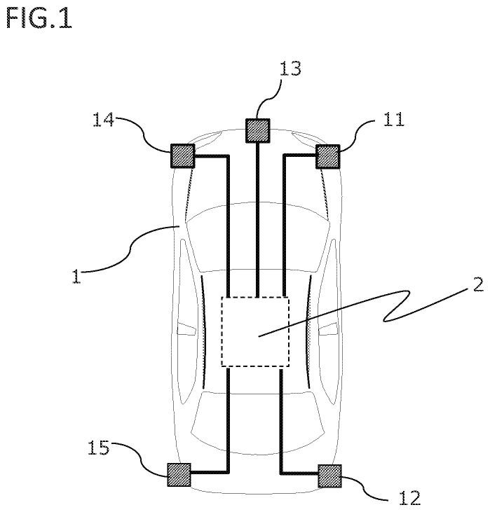

FIG. 1 is a schematic configuration diagram of an on-vehicle object detection system. As an object detection apparatus, radar apparatuses 11 to 15 are installed at front, rear, left, and right portions of a vehicle 1. A control apparatus 2 receives, aggregates, and processes information from the radar apparatuses 11 to 15.

The radar apparatuses 11 to 15 each have a radar function of emitting a radio wave, receiving a reflected wave from a target, and measuring the distance to the target, a relative speed and an angle with respect to the target, a reflection level from the target, and the like. The reflection level from the target may be an instantaneously-measured value or a value obtained by averaging values measured for a certain time period. Through the averaging, sudden change in relative positional relationship with the target can be suppressed, and the determination result can be stabilized. As long as reception results of reflected waves of at least two radar apparatuses are inputted to the control apparatus 2, an object detection apparatus abnormality determination unit 222 described later can perform determination operation. The object detection apparatus may be, other than a radar apparatus, another sensor that is configured to be able to detect a target and detect the reflection level of the target, and may be LIDAR (Laser Imaging Detection and Ranging), an ultrasonic sensor, or the like. The following description is based on a radar apparatus, but similar functions and operations are exhibited also in the case of another sensor. The radar apparatus is denoted as a radar in the drawings.

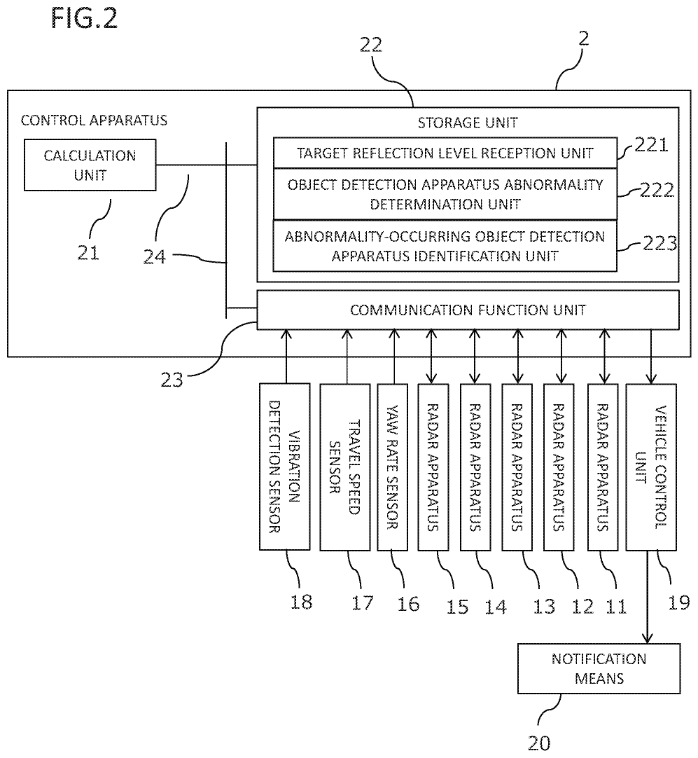

FIG. 2 is a block configuration diagram of the control apparatus 2. The control apparatus 2 includes a calculation unit 21, a storage unit 22, a communication function unit 23, and a bus 24 for performing bidirectional transmission/reception of a signal between these units. The calculation unit 21, the storage unit 22, and the communication function unit 23 are connected so as to be able to perform bidirectional communication via the bus 24. The calculation unit 21 is implemented as a calculation device such as a microcomputer or a DSP (Digital Signal Processor). The storage unit 22 is implemented as a RAM (Random Access Memory) or a ROM (Read Only Memory). The storage unit 22 includes a target reflection level reception unit 221, an object detection apparatus abnormality determination unit 222, and an abnormality-occurring object detection apparatus identification unit 223 that are for determining an object detection apparatus in which an abnormality has occurred.

The radar apparatuses 11 to 15, a yaw rate sensor 16, a travel speed sensor 17, a vibration detection sensor 18, and a vehicle control unit 19 are connected to the communication function unit 23 via respective signal lines. Detection information is inputted from the radar apparatuses 11 to 15, the yaw rate sensor 16, the travel speed sensor 17, and the vibration detection sensor 18, and a drive control signal and a measurement result of each radar apparatus 11 to 15 are outputted to the vehicle control unit 19. When an abnormality has occurred, an instruction for eliminating the abnormality or an instruction for stopping the radar apparatus 11 to 15 is outputted to the radar apparatus 11 to 15. Further, it is possible to notify a driver of the vehicle 1 of occurrence of an abnormality, via the vehicle control unit 19 by notification means 20.

The yaw rate sensor 16 detects a turning movement of the vehicle 1. As another means, a steering wheel angle sensor or the like can be used instead.

The travel speed sensor 17 is a sensor that detects a travel speed of the vehicle 1, and an example thereof is a sensor that detects a rotation speed of a wheel.

The vibration detection sensor 18 has installed therein a sensor that detects a change in a pitch angle of the vehicle. In a method, when the pitch angle in a time period determined in advance has changed by not less than a threshold, it is determined that the vehicle has vibrated.

The control apparatus 2 may perform a so-called sensor fusion process in which processing is performed using a combination of the distance from the radar apparatus 11 to 15 to the target, and the relative speed and the angle with respect to the target, in combination with a sensing result from a monocular camera, a stereo camera, LIDAR, an ultrasonic sensor, or the like. A configuration may be adopted in which a result of this sensor fusion is directly transmitted to the control apparatus 2, or a drive control signal for causing a vehicle control application to operate on the basis of the sensor fusion result is transmitted to the control apparatus 2.

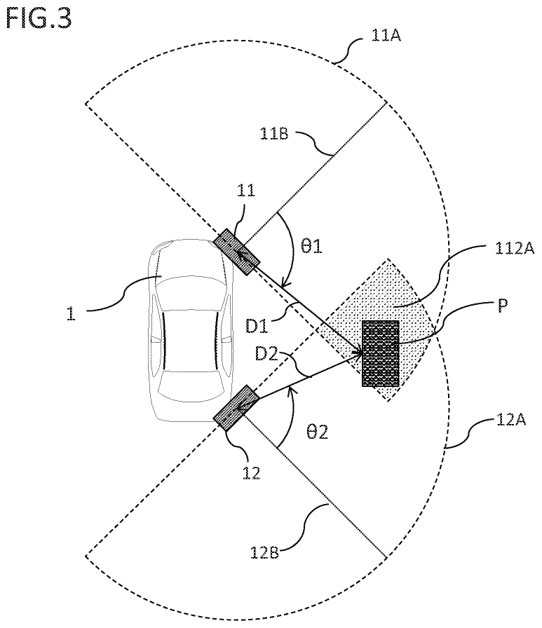

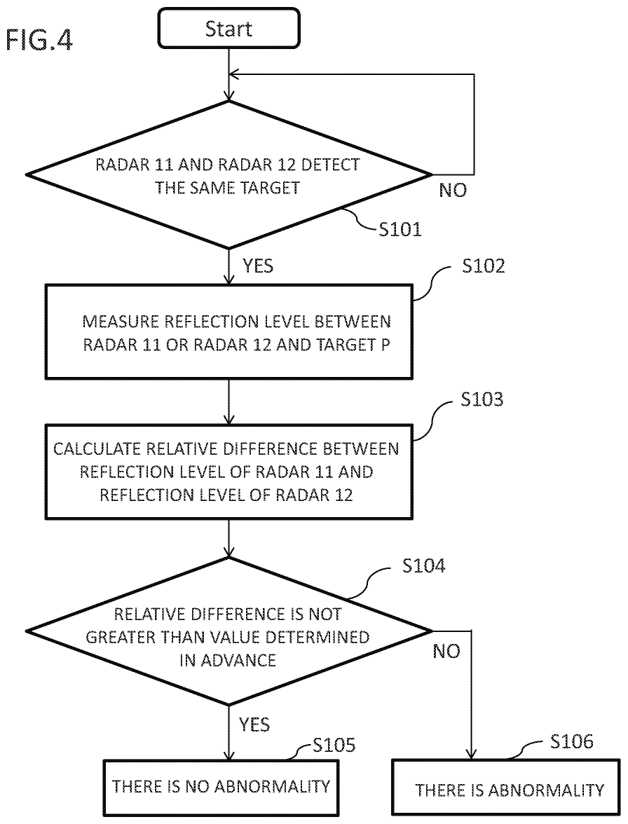

Next, basic operation of the on-vehicle object detection system is described with reference to FIG. 3 and FIG. 4.

First, in FIG. 3, a target P in a region 112A where a coverage region 11A of the radar apparatus 11 and a coverage region 12A of the radar apparatus 12 overlap each other is detected by the radar apparatus 11 and the radar apparatus 12. Position information of the detected target P is a relative coordinate composed of azimuth angles θ1, 62 (the angle from a radar axis center 11B, 12B to the target P) and distances D1, D2 viewed from the radar apparatus 11 and the radar apparatus 12. Therefore, the relative coordinate is converted into a coordinate according to a vehicle coordinate system based on an arbitrary point of the vehicle 1. Among a plurality of targets that have been detected, targets for which the difference in position (distance) is smaller than a threshold determined in advance is regarded as the same target, and these targets are determined as a comparison subject (step S101 in FIG. 4). Such determination may be performed by the object detection apparatus abnormality determination unit 222.

When comparison is performed for the same target at the same time, if the presence of the target in an area where the coverage regions serving as detection ranges of a plurality of radar apparatuses are common is used as a condition, targets to be candidates for comparison can be narrowed. Accordingly, reduction of the processing amount in the control apparatus can be expected.

For determination that targets are the same target, when not only the difference in the distance between positions but also the difference in the advancement azimuth and the difference in the advancing speed being smaller than respective thresholds are taken into consideration, the sameness can be determined in a finer manner. As for the distance, a general Euclidean distance may be used.

Next, using the radar apparatus 11 and the radar apparatus 12, reflection levels of the target P determined as the comparison subject are measured in the target reflection level reception unit 221 (step S102). The object detection apparatus abnormality determination unit 222 compares the measured reflection levels and determines whether the radar apparatus 11 or the radar apparatus 12 has an abnormality. Specifically, a relative difference between the reflection level of the target P obtained by the radar apparatus 11 and the reflection level of the target P obtained by the radar apparatus 12 is determined (step S103), and the relative difference is compared with a value determined in advance (step S104). When the relative difference is not greater than the value determined in advance, it is determined that there is no abnormality (step S105).

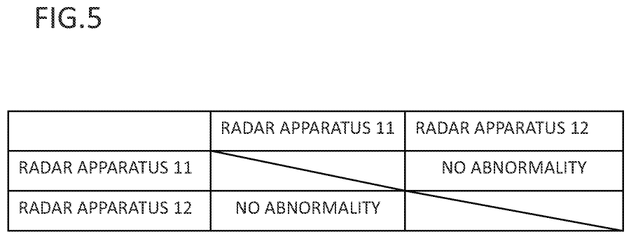

FIG. 5 shows an abnormality determination result. In FIG. 5, the row of the radar apparatus 11 on the left side shows the state of the radar apparatus 12 viewed from the radar apparatus 11, and indicates that there is no abnormality in this determination. In FIG. 5, the row of the radar apparatus 12 on the left side shows the state of the radar apparatus 11 viewed from the radar apparatus 12, and indicates that there is no abnormality in this determination.

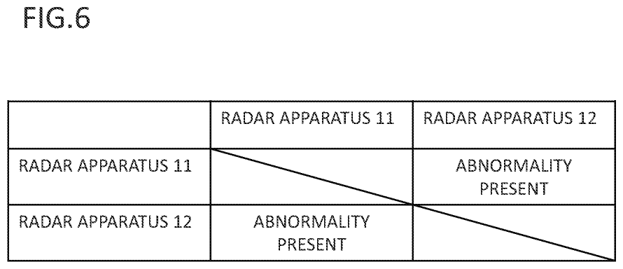

When the difference between the target reflection level detected by the radar apparatus 11 and the reflection level of the target P detected by the radar apparatus 12 is greater than the value determined in advance, it is determined that there is an abnormality (step S106 in FIG. 4). In FIG. 6, the row of the radar apparatus 11 on the left side shows the state of the radar apparatus 12 viewed from the radar apparatus 11, and indicates that there is an abnormality in this determination. In FIG. 6, the row of the radar apparatus 12 on the left side shows the state of the radar apparatus 11 viewed from the radar apparatus 12, and indicates that there is an abnormality in this determination. In this manner, as the on-vehicle object detection system, it is possible to determine the presence of an abnormality that has occurred in an installed radar apparatus, through comparison of target reflection levels between radar apparatuses. Here, examples of the abnormality include decreased performance and the like due to an axial deviation in the vertical direction or attachment of dirt, snow, or the like.

However, the above-described determination that there is an abnormality cannot identify which of the radar apparatus 11 and the radar apparatus 12 the abnormality has occurred in. For this, the difference between the average value of the target reflection levels of the radar apparatus 11 and the radar apparatus 12 and the target reflection level of the radar apparatus 11 or the radar apparatus 12 is calculated, and the radar apparatus that has a target reflection level for which this difference exceeds a value determined in advance may be identified by the abnormality-occurring object detection apparatus identification unit 223 as having an abnormality.

Further, the radar apparatus 11 may be provided with a function of self-determining the presence or absence of an abnormality, and when the radar apparatus 11 has self-determined that the radar apparatus 11 has no abnormality, the abnormality-occurring object detection apparatus identification unit 223 may identify that the radar apparatus 12 has an abnormality. As the self-determination means for an abnormality of the radar apparatus 11, in order to determine decreased performance of the radar apparatus, the following measures are known: a method in which a sensor (dirt attachment detection sensor) that monitors the presence or absence of an attached substance on the surface of the radar apparatus is mounted; a method in which the presence or absence of an attached substance on the surface of the radar apparatus is detected using information of the reflection intensity obtained by the radar apparatus; a method in which a sensor that detects an axial deviation amount is built in the radar apparatus to estimate an axial deviation amount; means for detecting an abnormality in an internal circuit; and the like. Any means for performing self-determination in a single radar apparatus may be used.

In such a configuration, without providing all of the radar apparatuses 11 to 15 with a self-diagnosis function, the presence or absence of occurrence of an abnormality can be estimated. Accordingly, the total cost of the on-vehicle object detection system can be reduced.

Even when each radar apparatus has a self-diagnosis function, determination may take time depending on the configuration of the self-diagnosis function in some cases. For example, there may be a case where travel data is accumulated for a long time period such as 1 minute or 10 minutes, and whether or not an abnormality has occurred is determined through statistical processing. However, each radar apparatus may not necessarily be able to accumulate in this time period a sufficient amount of data that allows determination of an abnormality, and there may be a case where abnormality determination is completed only in some radar apparatuses. Even in such a case, if the abnormality determination is completed in at least one radar apparatus, the presence or absence of abnormalities in the other radar apparatuses can be determined through relative comparison. Therefore, an abnormality in a radar apparatus can be found early.

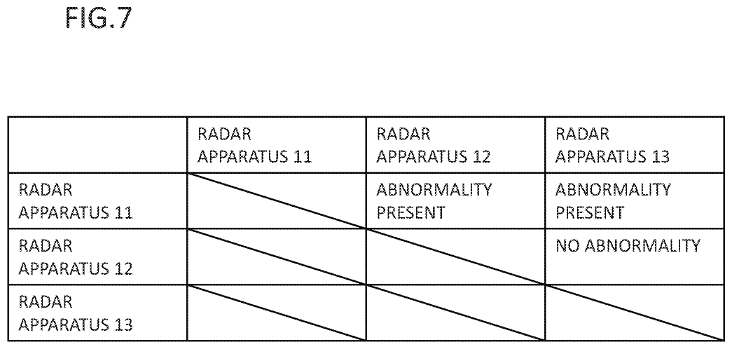

Next, operation of the abnormality-occurring object detection apparatus identification unit 223 when information of three radar apparatuses is used is described. Similar to the above-described case of the two radar apparatuses 11, 12, the same target is determined as a comparison subject, and reflection levels with respect to the target obtained by the radar apparatuses 11, 12, 13 are measured in the target reflection level reception unit 221. The measured reflection levels are compared with each other, and whether the radar apparatus 11, the radar apparatus 12, or the radar apparatus 13 has an abnormality is determined by the object detection apparatus abnormality determination unit 222. FIG. 7 shows the result of the determination. As understood from the description above, as for the triangular portion of the upper right half and the triangular portion of the lower left half in the table shown in FIG. 7, only the viewing direction, i.e., which radar apparatus views the state of the other radar apparatus, is different. Thus, the indications in the table will be merely opposite relative to each other. Therefore, the following description is given, with determination examples shown only in the upper right half.

In the object detection apparatus abnormality determination unit 222, as shown in FIG. 7, when it has been determined that

(1) there is an abnormality, as a result of comparison between the reflection level of the radar apparatus 11 and the reflection level of the radar apparatus 12,
(2) there is an abnormality, as a result of comparison between the reflection level of the radar apparatus 11 and the reflection level of the radar apparatus 13, and
(3) there is no abnormality, as a result of comparison between the reflection level of the radar apparatus 12 and the reflection level of the radar apparatus 13, the abnormality-occurring object detection apparatus identification unit 223 can identify that an abnormality has occurred in the radar apparatus 11. This utilizes a fact that it is difficult to consider that, with respect to the radar apparatus 12 and the radar apparatus 13, abnormalities in which the target reflection levels are at similar levels occur similarly in a plurality of radar apparatuses in the system. Therefore, although the radar apparatus in which an abnormality has occurred cannot be identified by using only two radar apparatuses, the radar apparatus in which an abnormality has occurred can be identified in the on-vehicle object detection system in which not less than three radar apparatuses are installed.

As described above, in embodiment 1, target reflection levels are compared between a plurality of object detection apparatuses. Therefore, even when targets are positioned at various distances and the reflection levels vary in accordance therewith, the presence or absence of an abnormality can be determined. Accordingly, the presence or absence of an abnormality can be determined in a greater variety of traveling environments and in a shorter time period than in a case where a single object detection apparatus determines an abnormality thereof.

[Technique for Preventing Erroneous Operation]

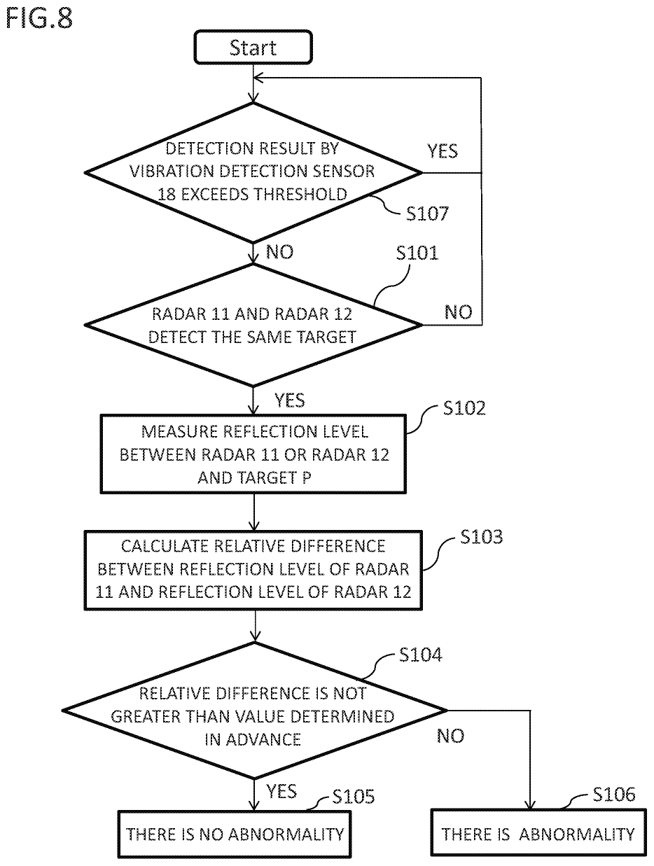

In order to prevent erroneous operation of the on-vehicle object detection system of embodiment 1, as shown in FIG. 8, the vibration detection sensor 18 detects the pitch angle in a certain time period, and when the pitch angle has changed by not less than a threshold, it may be determined that the vehicle 1 has vibrated, and detection of the target by the radar apparatus and determination as to the presence or absence of an abnormality in the radar apparatus may be prevented from being performed (step S107 in FIG. 8). That is, when the vehicle 1 has vibrated, e.g., when the vehicle 1 has gone over a small step or the like, the radar apparatus may be directed upwardly or downwardly relative to the target. In such a case, the angle of the radar apparatus with respect to the target is changed by the amount corresponding to the step. Under this influence, an erroneous abnormality determination may be made. Therefore, when vibration of the vehicle 1 has been detected, the process returns to the beginning without performing abnormality determination, and is started with detection of the target. In FIG. 8, detection of vibration by the vibration detection sensor 18 is performed first. However, regardless of which stage, before the abnormality determination, vibration is detected in, the process may be returned to the beginning without performing abnormality determination.

[Normalization of Target Reflection Level]

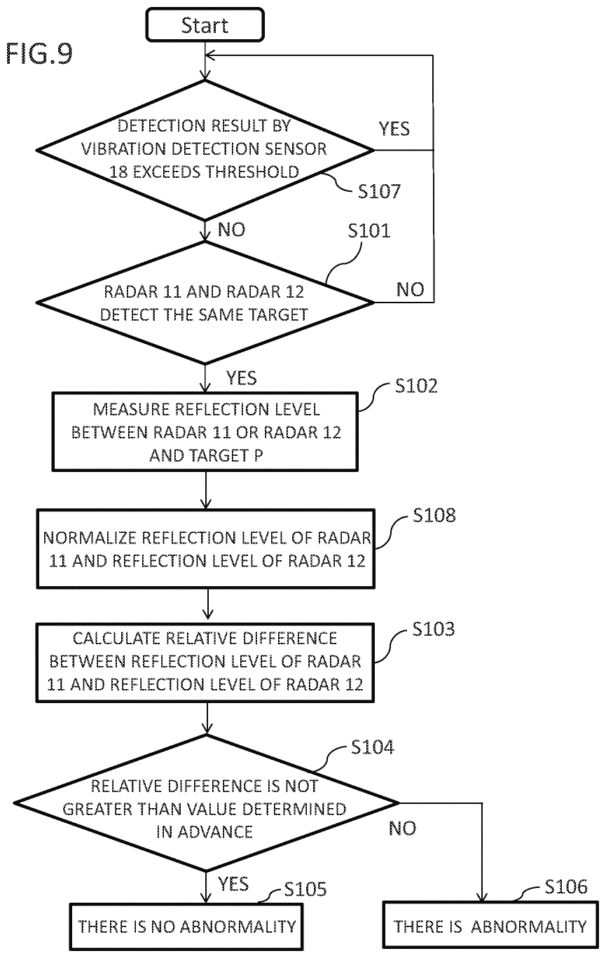

The radar apparatuses 11, 12, and 13 described in embodiment 1 are not necessarily mounted with a completely same specification and at a completely same height. In such a case, as shown in FIG. 9, for example, it is preferable that the target reflection levels are normalized between the radar apparatus 11 and the radar apparatus 12 (step S108 in FIG. 8) and the target reflection levels can be compared on the basis of the same index between the radar apparatuses.

Examples of the normalization subject include (1) to (5) below. These may be used individually or in combination. The normalization technique is not limited to (1) to (5).

(1) The reflection intensity obtained by a radar apparatus is known to be in inverse proportion of the fourth power of the distance to the target. Since a millimeter wave radar can detect the distance to the target, if each obtained target reflection level is corrected with an attenuation corresponding to the fourth power of the distance, the target reflection levels between radar apparatuses can be compared, with the influence of the distance suppressed.

(2) An antenna gain in the horizontal direction is also a correction subject for normalization. An antenna has directivity in a predetermined direction. Characteristics of this directivity are obtained in advance. Then, target reflection intensity is corrected by an amount corresponding to the antenna gain in the horizontal direction by using an angle measurement value in the horizontal direction obtained by the radar apparatus. Accordingly, the target reflection levels can be compared while the influence of the difference in the antenna gain in the horizontal direction between radar apparatuses is suppressed.

(3) An antenna gain in the vertical direction is also a correction subject for normalization. When the axis is not deviated in the vertical direction, the direction of the target, when viewed from a radar apparatus, is uniquely determined by the mounting height and the distance to the target. The antenna gain in the vertical direction is obtained in advance. Then, on the basis of information of the distance to the target obtained by the radar apparatus, the angle in the vertical direction between the radar apparatus and the target is determined, and correction of the antenna gain in the vertical direction is performed. Accordingly, the target reflection levels between radar apparatuses can be compared while the influence of the difference in the antenna gain in the vertical direction between the radar apparatuses is suppressed.

(4) Characteristics of hardware forming a radar apparatus are also a correction subject for normalization. For example, there are cases where, in a radar apparatus, a signal received by an antenna is inputted to an AD converter through a lowpass filter, a highpass filter, an amplifier, and the like. In such a case, when the target reflection intensity is corrected in consideration of the characteristics of these circuit components, the target reflection levels can be compared while the influence of the difference in the characteristics of the hardware of the radar apparatuses is suppressed.

(5) A radar cross section (RCS) indicating the reflecting ability of a target with respect to an incident radar wave is estimated, and this estimated value may be used instead of a normalized target reflection intensity. The radar cross section can be calculated using a radar equation on the basis of the reflected power from the target, the distance between the antenna and the target, characteristics of the antenna, hardware characteristics of the radar, and the like. Further, results in the form of a table created in advance with a range of representative values and steps determined in advance may be referred to. For creation of the table, results calculated by using a radar equation may be used, or results actually measured by using a reflector for which the radar cross section is known may be used.

It should be noted that normalization of the target reflection level is not necessarily essential. For example, even when normalization is not performed, if there is no large difference in the value of the target reflection level between radar apparatuses, and abnormality determination for a desired radar apparatus can be performed, the normalization is not essential. In addition, when all of the radar apparatuses have the same specification and the same mounting condition, the normalization is not essential.

[Measures to be Taken when it is Determined that there is an Abnormality]

A result of determination, by the object detection apparatus abnormality determination unit 222, that there is an abnormality is notified to the vehicle control unit 19 via the communication function unit 23 shown in FIG. 2. The vehicle control unit 19 having received the notification of the abnormality becomes able to stop vehicle control or restrict a part of operation of the vehicle control.

Further, on the basis of an instruction from the vehicle control unit 19, the notification means 20 may notify the driver of the occurrence of an abnormality, and urge the driver to check, for example, whether or not the radar apparatus is dirty.

When the difference in the target reflection level between radar apparatuses is small, the degree of abnormality is considered to be small. In such a case, the degree of abnormality may be determined in a stepped manner. For example, when the degree of abnormality is small, a specific vehicle control application may be stopped or may have the function thereof suppressed. For example, during high speed traveling, an ability of detecting an object far away is required. In contrast, during low speed traveling, even if the ability of detecting is available only for a short distance, e.g., not greater than 100 m, a vehicle control application such as ACC (Adaptive Cruise Control) or AEB (Automatic Emergency Braking) is not significantly influenced. Therefore, the operation of the application may be, for example, allowed to be continued during occurrence of such an abnormality.

Further, the object detection apparatus abnormality determination unit 222 may notify the radar apparatus 11 to 15 of the presence or absence of occurrence of an abnormality. The radar apparatus that has been notified of an abnormality becomes able to also execute an operation for eliminating the abnormality. For example, as an abnormality occurring in a radar apparatus, there is a possible case where the radar apparatus cannot appropriately receive reflection from the target due to attachment of snow. For such a case, a heater or the like may be mounted to the radar apparatus 11 to 15.

In a configuration in which the ambient atmosphere temperature can be obtained, when the ambient atmosphere temperature is lower than a predetermined temperature and the object detection apparatus abnormality determination unit 222 has determined that there is an abnormality, a heater may be operated for a certain time period to monitor whether or not the abnormality is eliminated as a result of snow being melted.

In a case where a radar apparatus in which an abnormality has occurred can be identified by the abnormality-occurring object detection apparatus identification unit 223, notification of occurrence of an abnormality may be issued only to the radar apparatus, to cause a heater to be operated. In a case where a radar apparatus in which an abnormality has occurred cannot be identified, notification of occurrence of an abnormality of the on-vehicle object detection system is issued to all radar apparatuses as the apparatuses that have been determined as having an abnormality by the object detection apparatus abnormality determination unit 222, to cause heaters of all of the radar apparatuses to operate, and whether the abnormality is eliminated may be monitored. In a case where the abnormality is not eliminated even when the heater is operated, the abnormality may be of another kind. Therefore, for example, when an axial deviation in the vertical direction of a radar apparatus is suspected, an operation of correcting the orientation of the axis may be performed.

Other than causing a radar apparatus to perform an operation of eliminating the abnormality, the operation of the radar apparatus itself may be stopped. Even when the radar apparatus in which an abnormality has occurred is allowed to continue to operate but when operation of the vehicle control application cannot be assured, if operation of the corresponding radar apparatus is stopped, power consumption of the on-vehicle object detection system can be reduced.

### Embodiment 2

Different from embodiment 1, a case where targets detected by the radar apparatuses 11, 12 are different objects but are of the same type is described. This type is, for example, a vehicle, a motorcycle, a bicycle, or a person, and the vehicle may be further subdivided into a truck, a bus, a passenger car, and the like.

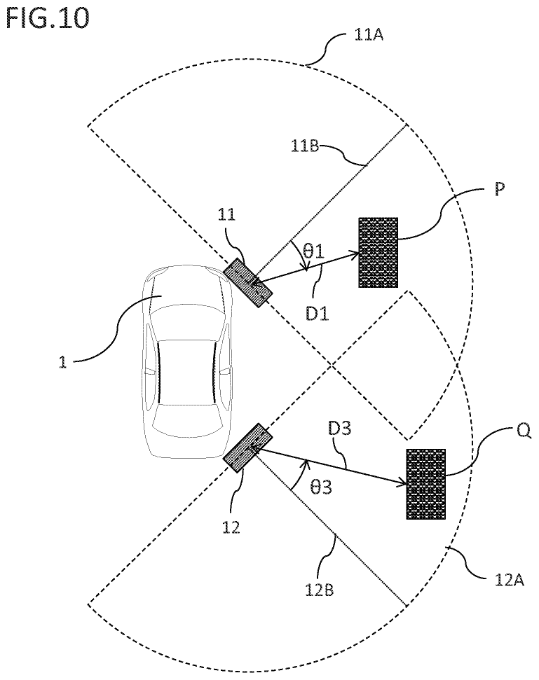

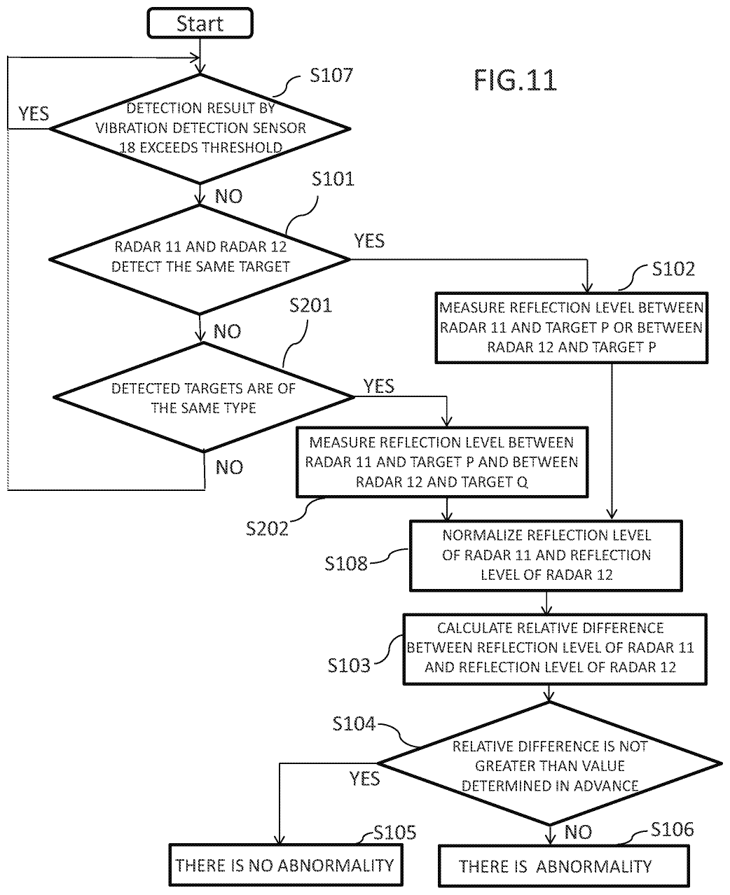

In FIG. 10, as described in embodiment 1, the radar apparatus 11 detects the target P and the radar apparatus 12 detects a target Q. Detection of the target P is the same as that described in embodiment 1. Position information of the detected target Q is a relative coordinate composed of an azimuth angle θ3 (the angle from a radar axis center 12B to the target Q) and a distance D3 viewed from the radar apparatus 12. Therefore, the relative coordinate is converted into a coordinate according to a vehicle coordinate system based on an arbitrary point of the vehicle 1. When it is not detected that the target P and the target Q are the same target, detection of the type is additionally performed (step S201 in FIG. 11).

That is, different from embodiment 1, the region where the detection of the type is performed is not necessarily the region where the coverage regions 11A, 12A overlap each other. For the detection of the type, a single radar apparatus may analyze characteristics of a reflected wave and discern the type based on a type estimated from the positional relationship between the target and the radar apparatus, or an optical camera may be separately provided and the type detected by the camera may be used to discern the type. Out of the detected targets, when it is detected that the types of the target P, Q are the same, the targets P, Q are determined as a comparison subject. The relative difference between the reflection level of the target P detected by the radar apparatus 11 and the reflection level of the target Q detected by the radar apparatus 12 is calculated, and the presence or absence of an abnormality is determined (steps S103 to S106). Details of this are the same as those in embodiment 1, as shown in FIG. 11. With respect to steps S107, S108 described in embodiment 1, these may be selectively performed as necessary as described in embodiment 1.

As described above, in embodiment 2, target reflection levels of the same type are compared between a plurality of object detection apparatuses. Therefore, even when the targets are not in a region where the coverage regions of the object detection apparatuses overlap and are positioned at various distances, and the reflection levels vary in accordance therewith, the presence or absence of an abnormality can be determined. Accordingly, the presence or absence of an abnormality can be determined in a greater variety of traveling environments and in a shorter time period than in a case where a single object detection apparatus determines an abnormality thereof.

### Embodiment 3

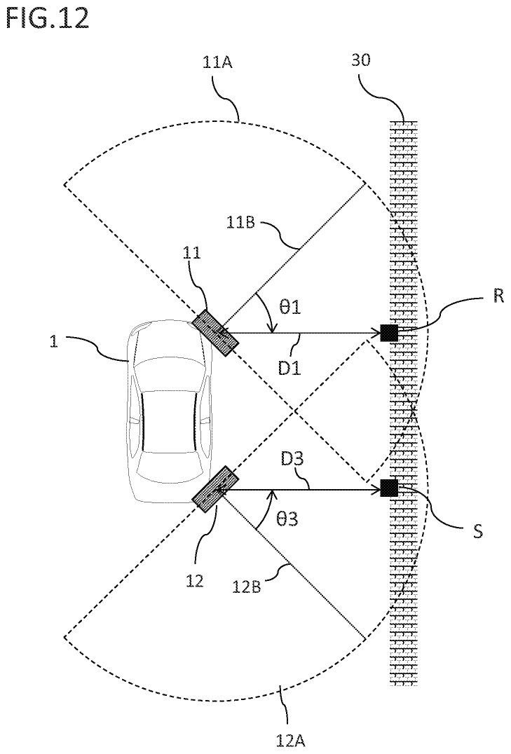

An example of a case where the type of the object detected by a radar apparatus is a side wall in particular is described. As shown in FIG. 12, in a case where a side wall 30 is present beside the vehicle 1, it is at one point just beside the radar apparatus 11, 12 that the reflection intensity of the target detected by the radar apparatus 11, 12 becomes greatest. A case where this point is detected as a target R, target S is assumed.

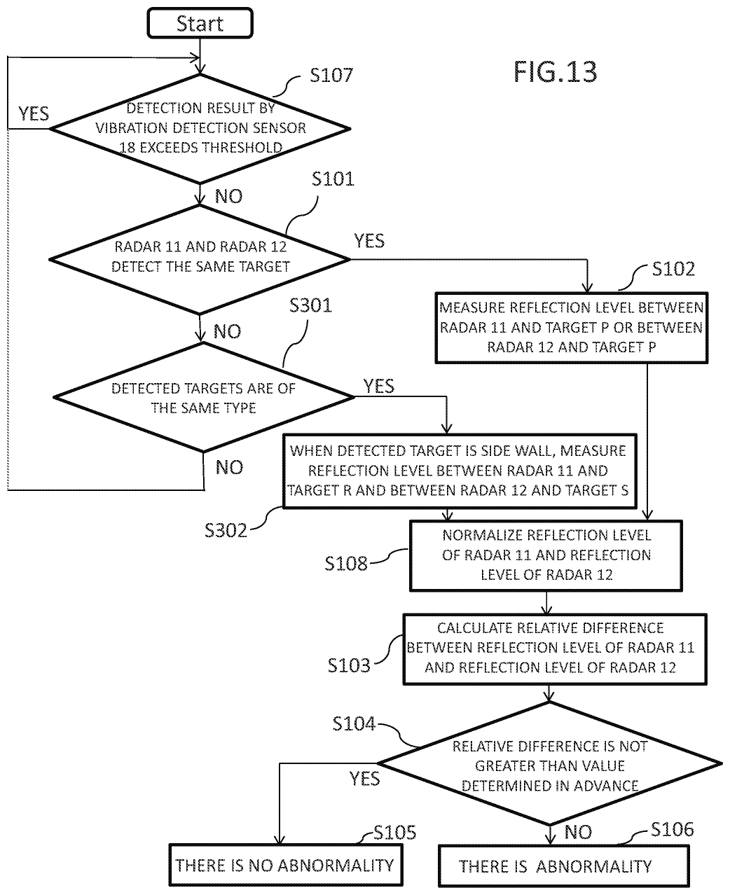

First, the radar apparatus 11 and the radar apparatus 12 respectively detect targets, and in addition, detection that the targets are of the same and are a side wall is performed (steps S301, S302 in FIG. 13). Similar to embodiment 2, for the detection of the type of the target, a single radar apparatus may analyze characteristics of a reflected wave or an optical camera may be separately provided and the type detected by the camera may be used. Alternatively, a map (not shown) that includes the position of the side wall 30 is used, and when the position of the detected target matches the position of the side wall 30 on the map, the type may be determined as a side wall. Even when the map does not include information of a side wall, if the boundary line of the road where the vehicle 1 is travelling is known, it may be estimated that there is a side wall at the boundary line. When the map includes tunnel information and if it is known that the vehicle 1 is travelling in a tunnel, the presence of a wall of the tunnel that can be regarded as a side wall may be estimated. Other than these, when, in the radar apparatus 11 and the radar apparatus 12, targets are detected just beside the vehicle 1 and at the same distance, it may be estimated that the side wall 30 is present.

Using the detection result that the target is the side wall 30, measurement of the reflection level at the target R on the side wall 30 with respect to the radar apparatus 11 and measurement of the reflection level at the target S on the side wall 30 with respect to the radar apparatus 12 are performed (step S302). Details of calculation of the relative difference between the reflection level at the target R and the reflection level at the target S, and of determination of the presence or absence of an abnormality are the same as those in embodiment 1, as shown in FIG. 13 (steps S103 to S106). Steps S107, S108 shown in FIG. 13 may be selectively performed as necessary, as described in embodiment 1.

As described above, in embodiment 3, the target reflection levels on a side wall are compared between a plurality of object detection apparatuses. Therefore, when the targets having the same reflection levels are consecutively present, the presence or absence of an abnormality can be determined in a shorter time period.

### Embodiment 4

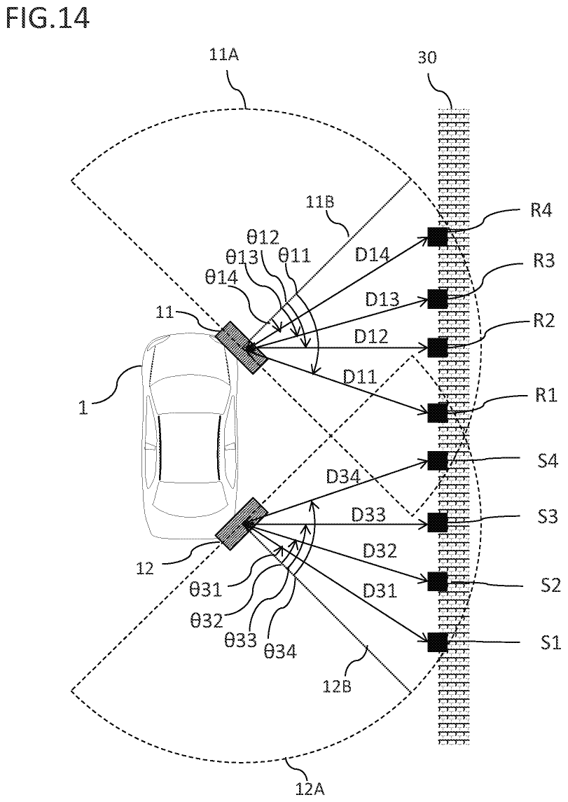

Another example using a side wall is described. As shown in FIG. 14, a case where, when the side wall 30 is present beside the vehicle 1, the radar apparatuses 11, 12 detect a plurality of targets, i.e., targets R1 to R4 and targets S1 to S4, is assumed.

First, the radar apparatus 11 and the radar apparatus 12 detect the target R1 to R4 and the target S1 to S4, respectively. Position information of the detected target R1 to R4 is a relative coordinate composed of an azimuth angle θ11 to θ14 (the angle from the radar axis center 11B to a corresponding target) and a distance D11 to D14 viewed from the radar apparatus 11. Position information of the target S1 to S4 is a relative coordinate composed of an azimuth angle θ31 to θ34 (the angle from the radar axis center 12B to a corresponding target) and a distance D31 to D34 viewed from the radar apparatus 12. The relative coordinate is converted into a coordinate according to a vehicle coordinate system based on an arbitrary point of the vehicle 1. Out of the plurality of detected targets, targets for which the difference in position, the difference in advancement azimuth, and the difference in advancing speed are smaller than respective thresholds determined in advance are regarded as the same target, and these targets are determined as a comparison subject. However, in this case, although the target R1 and the target S4 are present in a portion where the coverage regions of the radar apparatus 11 and the radar apparatus 12 overlap, these are not regarded as the same target.

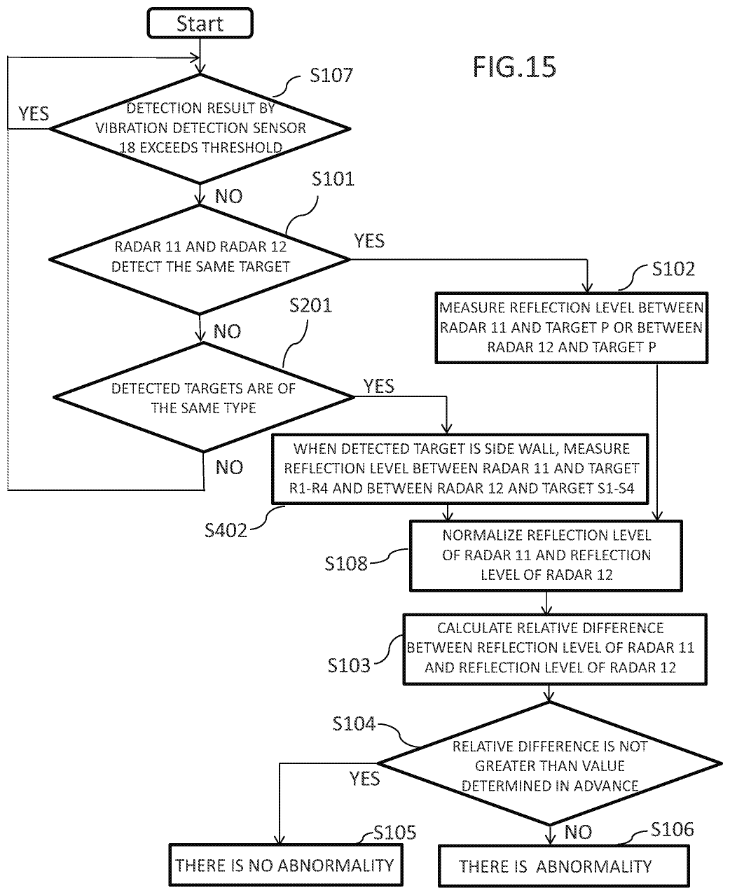

In addition to the detection of targets described above, detection of the type of each target is performed. The detection of the type is performed in a similar manner to that in embodiment 3. However, in this example in particular, the side wall is in a linear shape. Thus, utilizing the fact that the targets R1 to R4 detected by the radar apparatus 11 and the targets S1 to S4 detected by the radar apparatus 12 are linearly arranged in parallel to the advancing direction of the vehicle 1, these targets may be regarded as a side wall (step S402 in FIG. 15).

Details of determinations, using the detection result of the type of each target, that there is an abnormality or there is no abnormality are the same as those in embodiment 1. At this time, when determining the relative difference between the reflection levels, the sum or the average value of reflection levels of the targets R1 to R4 or the sum or the average value of reflection levels of the targets S1 to S4 may be used as the reflection level of the radar apparatus 11 and the reflection level of the radar apparatus 12, respectively.

The present embodiment is applicable not only to a side wall but also to a movable body such as a truck or a bus that is long in the front-rear direction.

Steps S107, S108 shown in FIG. 13 may be selectively performed as necessary, as described in embodiment 1.

As described above, in embodiment 4, a single object detection apparatus detects a plurality of the target reflection levels on a side wall. Therefore, that the targets having the same reflection levels are consecutively present can be detected in a shorter time period than by the system described in embodiment 3. Therefore, detection of a side wall can be performed in a shorter time period, and the time period for determining the presence or absence of an abnormality can also be further shortened.

### Embodiment 5

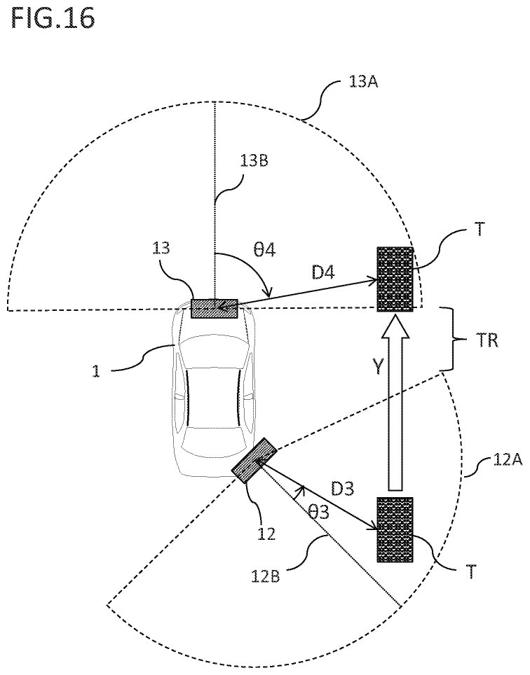

In this present embodiment, the presence or absence of an abnormality in an object detection apparatus is detected on the basis of a moving target. For example, in FIG. 16, the radar apparatus 12 and the radar apparatus 13 are installed on the right side when viewed from the vehicle 1. Therefore, when the vehicle 1 is passed by another vehicle during travelling, the radar apparatus 12 and the radar apparatus 13 detect the other vehicle as the same target T at temporally shifted timings. Therefore, if a configuration in which the reflection level of the target T detected by the radar apparatus 12 is stored, the target is tracked, and when the target T is detected also by the radar apparatus 13, the reflection levels of the target T are compared, is adopted, even when the target T is not present in the same coverage region between the radar apparatuses, the reflection levels of the same target can be compared.

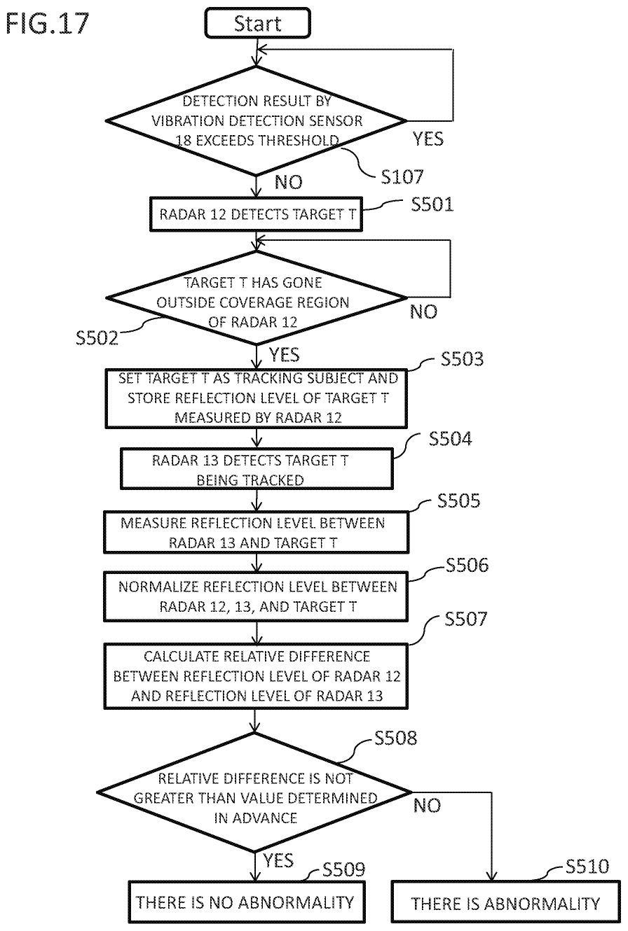

Specifically, with respect to the radar apparatus 12 and the radar apparatus 13 of which the coverage regions 12A, 13A do not overlap each other as shown in FIG. 16, the radar apparatus 12 detects the target T (step S501 in FIG. 17). Position information of the detected target T is a relative coordinate composed of an azimuth angle θ3 (the angle from the radar axis center 12B to the target T) and a distance D3 viewed from the radar apparatus 12. The relative coordinate is converted into a coordinate according to a vehicle coordinate system based on an arbitrary point of the vehicle 1.

When the detected target T has moved in the direction of an arrow Y in FIG. 16 so as to pass the vehicle 1 and has gone outside the coverage region 12A of the radar apparatus 12, the detected reflection level of the target T is stored, and further, the target T is marked as a tracking subject (step S502 in FIG. 17).

The tracking is continuously performed also while the target T is moving in a tracking section TR, and when the target T has finally entered the coverage region 13A of the radar apparatus 13, the radar apparatus 13 confirms the presence of the target T being tracked that matches the actually detected target (step S503). Position information of the target T detected by the radar apparatus 13 is a relative coordinate composed of an azimuth angle θ4 (the angle from a radar axis center 13B to the target T) and a distance D4 viewed from the radar apparatus 13. The relative coordinate is converted into a coordinate according to a vehicle coordinate system based on an arbitrary point of the vehicle 1. For confirmation of the target T, not only the position of the target but also the speed and the advancement azimuth thereof may be used. When the targets are confirmed to be the same target, the target reflection levels of these are compared and whether the radar apparatus 12 or the radar apparatus 13 has an abnormality is determined (steps S507 to S510 in FIG. 17) in a similar manner to that described in steps S103 to S106 in FIG. 9 of embodiment 1. Steps S107, S506 in FIG. 17 may be selectively performed as necessary, as described in embodiment 1.

For tracking of a target, a method of predicting the position of the target from the latest observed position, speed, and advancement azimuth on the assumption that linear uniform motion is performed, or a method of predicting the position through a Kalman filter, using time-series information of the position of the observed target may be used, for example. When the target stays in a tracking section for a long time period, in order to correspond to a case where the target changes the path, a certain time limit may be provided for tracking of the target, and when the time limit is exceeded, the tracking may be stopped, for example.

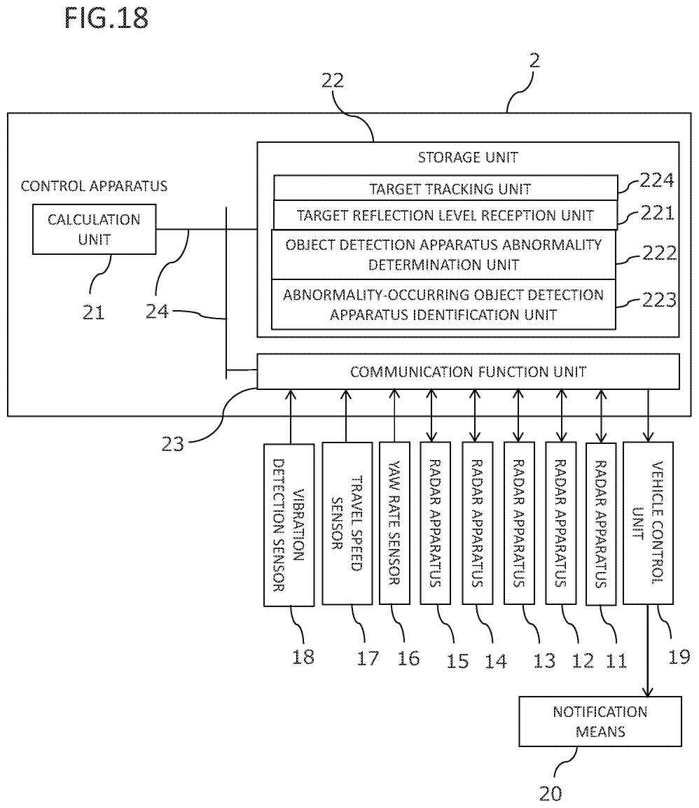

FIG. 18 is a block configuration diagram of the control apparatus 2 for performing embodiment 5. This configuration is the same as that in FIG. 2 except that a target tracking unit 224 for tracking movement of the target detected by the radar apparatus 12 or 15 is included in addition to the configuration described in embodiment 1. Therefore, detailed description of each component is omitted.

As described above, in embodiment 5, since a target of another object that is moving is detected, the reflection level can be detected by the object detection apparatus regardless of the presence or absence of a static object.

In embodiments 1 to 5, in order to simplify the description, cases where relative comparison is performed between two or three radar apparatuses have been described. However, embodiments 1 to 5 can be applied regardless of the number of radar apparatuses.

In each embodiment, description has been given assuming that the target to be detected is a movable body or a static object (side wall). As for the static object in particular, each embodiment can be applied not only to a side wall but also to a structure such as a utility pole, a sign, or a guardrail.

Although the present disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 vehicle
2 control apparatus
11, 12, 13, 14, 15 radar apparatus (object detection apparatus)
16 yaw rate sensor
17 travel speed sensor
18 vibration detection sensor
19 vehicle control unit
20 notification means
21 calculation unit
22 storage unit
23 communication function unit
24 bus
30 side wall
221 target reflection level reception unit
222 object detection apparatus abnormality determination unit
223 abnormality-occurring object detection apparatus identification unit
224 target tracking unit

1. An on-vehicle object detection system comprising:
a plurality of object detection apparatuses mounted to a vehicle;
a target reflection level reception circuitry to receive a plurality of target reflection levels detected by the plurality of object detection apparatuses; and
an object detection apparatus abnormality determination circuitry to calculate a difference between target reflection levels of two or more targets detected as a same target or a same type of target, and for determining, when the difference exceeds a range of values determined in advance, that any of the plurality of object detection apparatuses has an abnormality.

2. The on-vehicle object detection system according to claim 1, wherein
the object detection apparatus abnormality determination circuitry determines targets detected in a region where coverage regions of the plurality of object detection apparatuses overlap each other, to be the same target.

3. The on-vehicle object detection system according to claim 2, wherein
when a distance between target positions detected by the plurality of object detection apparatuses is less than a threshold determined in advance, it is determined that the targets are the same target.

4. The on-vehicle object detection system according to claim 2, wherein
a condition for determination that the targets are the same target is that a distance between target positions, a difference between advancement azimuths, and a difference between advancing speeds of targets detected by the plurality of object detection apparatuses are less than respective thresholds determined in advance.

5. The on-vehicle object detection system according to claim 1, comprising
a storage to store a first target reflection level detected by a first object detection apparatus among the plurality of object detection apparatuses; and
a target tracking circuitry to track a position of a target detected by the first object detection apparatus and for predicting a future position, wherein
when the target tracked by the target tracking circuitry has been detected by a second object detection apparatus, the target tracked by the target tracking circuitry and the target detected by the second object detection apparatus are determined to be the same target, and a difference between a second target reflection level having been detected and the first target reflection level having been stored is calculated.

6. The on-vehicle object detection system according to claim 1, wherein
the object detection apparatus abnormality determination circuitry determines that targets detected by the plurality of object detection apparatuses are targets of the same type on the basis of a discernment result, of a target, outputted by each object detection apparatus or a type estimated from a positional relationship between the target and the object detection apparatus.

7. The on-vehicle object detection system according to claim 1, further comprising
an abnormality-occurring object detection apparatus identification circuitry to identify an object detection apparatus in which an abnormality has occurred, from the plurality of object detection apparatuses that have been determined as having an abnormality by the object detection apparatus abnormality determination circuitry.

8. The on-vehicle object detection system according to claim 7, wherein
the abnormality-occurring object detection apparatus identification circuitry calculates a difference in a combination of target reflection levels of respective three or more object detection apparatuses, and identifies an object detection apparatus in which an abnormality has occurred, on the basis of a combination of object detection apparatuses that have been determined as having an abnormality and a combination of object detection apparatuses that have been determined as having no abnormality.

9. The on-vehicle object detection system according to claim 1, wherein
the object detection apparatus abnormality determination circuitry identifies that, between the plurality of object detection apparatuses, the plurality of object detection apparatuses for which a difference between the target reflection levels is in a range determined in advance have no abnormality, and the plurality of object detection apparatuses for which a difference between the target reflection levels is outside the range determined in advance have an abnormality.

10. The on-vehicle object detection system according to claim 7, wherein
the abnormality-occurring object detection apparatus identification circuitry calculates a difference between an average value of the target reflection levels of the plurality of object detection apparatuses and a target reflection level of each object detection apparatus, and identifies an object detection apparatus that has a target reflection level for which the difference exceeds a value determined in advance, as having an abnormality.

11. The on-vehicle object detection system according to claim 7, wherein
among the plurality of object detection apparatuses, at least one object detection apparatus performs self-diagnosis about presence or absence of occurrence of an abnormality, and the object detection apparatus abnormality determination circuitry identifies, on the basis of a result of the self-diagnosis, presence or absence of occurrence of an abnormality in remaining object detection apparatuses.

12. The on-vehicle object detection system according to claim 1, wherein
when performing comparison of the target reflection levels between the plurality of object detection apparatuses, the object detection apparatus abnormality determination circuitry performs normalization of the target reflection levels and then performs the comparison.

13. The on-vehicle object detection system according to claim 12, wherein
in the normalization of the target reflection levels, change in a target reflection intensity due to a distance is corrected.

14. The on-vehicle object detection system according to claim 12, wherein
in the normalization of the target reflection levels, change in a target reflection intensity due to an antenna gain is corrected.

15. The on-vehicle object detection system according to claim 12, wherein
in the normalization of the target reflection levels, change in a target reflection intensity due to a characteristic of hardware forming the object detection apparatus is corrected.

16. The on-vehicle object detection system according to claim 12, wherein
when the object detection apparatus is a radar apparatus, an intensity of each target reflection level is corrected on the basis of an RCS estimation value.

17. The on-vehicle object detection system according to claim 1, wherein
when vibration of the vehicle has been detected, the object detection apparatus abnormality determination circuitry does not perform determination.

18. The on-vehicle object detection system according to claim 1, wherein
the object detection apparatus abnormality determination circuitry notifies a vehicle controller of an abnormality determination result.

19. The on-vehicle object detection system according to claim 18, wherein
the vehicle controller stops a function of vehicle control or restricts a function of vehicle control on the basis of the notified abnormality determination result.

20. The on-vehicle object detection system according to claim 1, wherein
the object detection apparatus abnormality determination circuitry notifies an object detection apparatus of an abnormality determination result.

21. The on-vehicle object detection system according to claim 20, wherein
the object detection apparatus that has been notified of the abnormality determination result performs an operation of eliminating an abnormality.
